(19) United States
(12) Patent Application Publication
(10) Pub. No.: US 2012/0091102 A1
(43) Pub. Date: Apr. 19, 2012

(54) CONTACT FOR VACUUM INTERRUPTER

(75) Inventors: Sung Tae Kim, Chungcheongbuk-Do (KR); Byung Chul Kim, Chungcheongbuk-Do (KR)

(73) Assignee: LSIS CO., LTD.

(21) Appl. No.: 13/276,215

(22) Filed: Oct. 18, 2011

(30) Foreign Application Priority Data
Oct. 18, 2010 (KR) 10-2010-0101552

(51) Int. Cl. H01H 33/664

(52) U.S. Cl. 218/128

(57) ABSTRACT

According to the present invention, there is disclosed a contact of the vacuum interrupter, comprises a plurality of slot portions formed in an extended manner toward an outer circumferential surface from a plurality of positions, respectively, spaced apart from the center of a contact surface, and a petal portion formed between a pair of the adjacent slot portions, and to minimize a mechanical fragile part having a narrow width in the petal portion while inducing the rotational movement of an arc, each of the slot portion comprises a first end portion closed and adjacent to the center, a second end portion open and adjacent to the outer circumferential surface, a first slot portion linearly extended from the first end portion, and a second slot portion linearly extended to the second end portion by bending the first slot portion at a predetermined angle.

### CROSS-REFERENCE TO a RELATED APPLICATION

Pursuant to 35 U.S.C.§119(a), this application claims the benefit of earlier filing date and right of priority to Korean Application No. 10-2010-0101552, filed on Oct. 18, 2010, the contents of which is incorporated by reference herein in its entirety.

### BACKGROUND OF THE INVENTION

1. Field of the Invention

The present invention relates to a vacuum interrupter, which is a core contacts mechanism of a vacuum circuit breaker (hereinafter, abbreviated as VCB), and more particularly, to a contact of the vacuum interrupter having a quick arc extinguishing performance and an excellent mechanical strength as tolerance to a mechanical stress imposed on an electrode when a movable contact and stationary contact are being brought into contact with each other.

2. Description of the Conventional Art

An example of the configuration of a typical vacuum interrupter will be described below with reference to FIG. 1.

As illustrated in FIG. 1, in general, a vacuum interrupter may comprises an insulation container 9 formed of a pottery material, such as ceramic having an excellent electrical insulation characteristic and a superior thermal resistance, at which upper and lower portions thereof are open, respectively, a stationary electrode 4 inserted into the insulation container 9 and at an end portion of which a stationary contact 3 is provided and to the other end portion of which for instance a power source side is electrically connected, and a movable electrode 1 inserted into the insulation container 9 and at an end portion of which a movable contact 2 is provided and to the other end portion of which for instance an electrical load side is electrically connected.

Reference numeral 5 may designate a metallic sealing bellows movably supporting the movable electrode 1, and reference numeral 6 may designate a shielding plate provided at the movable electrode 1 to shield the bellows 5 from an arc in a protective manner.

Reference numeral 7 may designate a first seal cup welded and provided in a stationary manner to the insulation container 9 to seal between a lower opening portion of the insulation container 9 and the movable electrode 1, and reference numeral 8 may designate a second seal cup welded and provided to be fixed to the insulation container 9 to seal between a upper opening portion of the insulation container 9 and the stationary electrode 4.

Reference numeral 10 may designate a central shielding plate provided at the center of the insulation container 9 to protect an inner wall surface of the insulation container 9 from an arc.

A typical vacuum interrupter having the foregoing configuration, when the movable electrode 1 in FIG. 1 moves upward by a driving force transferred from an actuator having a not shown driving source such as a spring or a motor and links, the movable contact 2 provided at an end portion of the movable electrode 1 may contact with the stationary contact 3. Accordingly, the electric load side electrically connected to the movable electrode 1 and the power source side electrically connected to the stationary electrode 4 are electrically connected to each other, and thus the operating state becomes a closed circuit state.

When the movable electrode 1 moves downward by a driving force transferred from the actuator having the not shown driving source, the movable contact 2 provided at an end portion of the movable electrode 1 is separated from the stationary contact 3. Accordingly, the electric load side electrically connected to the movable electrode 1 and the power source side electrically connected to the stationary electrode 4 are electrically separated from each other, and thus the operating state becomes a open circuit state.

Meanwhile, when the circuit is open, as illustrated in FIG. 2, an arc (A) occurs between the movable contact 2 and the stationary contact 3, and an arc current (I_{arc}) flows by the arc (A), and a magnetic field (B) due to the arc current (I_{arc}) is formed around the arc current (I_{arc}). Then, the arc (A) receives a horizontal force, i.e., the so-called a Lorentz force, in accordance with a distance (L) between the movable contact 2 and the stationary contact 3 and the magnetic field (B). Accordingly, the arc pushed outward by a Lorentz force rotates on a contact surface along the shape of an electrical conducting path, called a plurality of petals on the movable contact 2 and the stationary contact 3 as illustrated in FIG. 3.

Meanwhile, the configuration of a contact of the vacuum interrupter according to two examples in the related art will be described with reference to FIGS. 4 through 7.

A contact of the vacuum interrupter in FIGS. 4 through 7 may have a horizontal magnetic field type contact configuration as illustrated in FIG. 3. The horizontal magnetic field type contact configuration may mean a magnetic field perpendicular to the current is formed in a horizontal direction because the direction of a current has an axial direction (namely, a vertical direction) as shown in the path of “a→b→c→d→e” using arrows. A contact of the vacuum interrupter in FIGS. 4 through 7 having the horizontal magnetic field type contact configuration will be described below.

In case of a vacuum interrupter having the horizontal magnetic field type contact configuration, an insulated status between contacts, namely, a status in which a space between contact is completely broken, may be immediately made according to whether an arc is extinguished by quickly rotating metal vapor in the arc generated between the contacts being opened and separated from each other on the contact surface due to a fault current such as a short-circuit current on the circuit, thereby determining the success or failure of effective circuit breaking.

Accordingly, in order to enhance a rotational force for rotating metal vapor in an arc, the scheme of enhancing a length of the petals 2a, 3a of the contacts 2, 3 has been carried out according to an example of the related art as illustrated in FIGS. 4 and 5.

In case of an example of the related art, it may be effective in quickly rotating metal vapor in an arc by increasing the length of the petals 2a, 3a, but also may have a drawback in which the diameter of the vacuum interrupter increases as increasing the diameter (φ) of the contacts 2, 3 and moreover the size of a vacuum circuit breaker employing the vacuum interrupter increases.

Furthermore, as illustrated in FIG. 4, the width (W) of a bended portion of the petals 2a, 3a is narrow as illustrated in FIG. 4, and thus the deformation and damage of contacts may happen due to a mechanical shock during a contacts closing operation of the vacuum interrupter, thereby causing a problem of drastically reducing contacts switching characteristics.

Meanwhile, in case of another example of the related art as illustrated in FIGS. 6 and 7, it has a feature that the diameter of the contacts 2, 3 does not increase while increasing the length (l) of the petals 2a, 3a.

In case of another example of the related art as illustrated in FIGS. 6 and 7, it may have an effect of not increasing the size of the vacuum interrupter and vacuum circuit breaker since it is effective in quickly rotating metal vapor in an arc by increasing the length (l) of the petals 2a, 3a and there is no increase in the length thereof.

However, as illustrated in FIG. 6, the width (Ws) of a starting portion of the petals 2a, 3a is narrow as illustrated in FIG. 6, and thus the deformation and damage of the contacts may happen due to a mechanical shock during a contacts closing operation of the vacuum interrupter, thereby causing a problem of drastically reducing contacts switching characteristics.

### SUMMARY OF THE INVENTION

Accordingly, the present invention is contrived to solve the problems in the related art, and an object of the present invention is to provide a contact of the vacuum interrupter in which the length of a petal is long to obtain an excellent extinguishing performance, and the diameter of the contact is not large as well as mechanical deformation and damage thereof can be prevented even when a mechanical shock is applied at the time of opening or closing the contact, thereby maintaining a mechanical strength thereof.

The objective of the present invention may be accomplished by providing a contact for a vacuum interrupter having a movable contact and a stationary contact, wherein the movable contact and stationary contact, respectively, comprises a plurality of slot portions formed in an extended manner toward an outer circumferential surface from a plurality of positions, respectively, spaced apart from the center of a contact surface, and a petal portion formed between a pair of the adjacent slot portions, and to minimize a mechanical fragile part having a narrow width in the petal portion while inducing the rotational movement of an arc, each of the slot portion comprises a first end portion that is closed and adjacent to the center; a second end portion that is open and adjacent to the outer circumferential surface; a first slot portion linearly extended from the first end portion; and a second slot portion linearly extended to the second end portion by bending from the first slot portion at a predetermined angle.

The contact for a vacuum interrupter according to the present invention may further comprise a central contact groove portion concavely formed with a predetermined diameter from the center of the contact, and it may be more effective that a distance from an outer circumferential surface of the central contact groove portion to the first slot portion has a predetermined first distance to induce a rotational movement of the arc.

In the contact for a vacuum interrupter according to the present invention, it may be more effective that the predetermined first distance may be greater than zero and less than or equal to 5 mm.

In the contact for a vacuum interrupter according to the present invention, it may be more effective that the predetermined angle may be greater than or equal to 30 degrees and less than or equal to 60 degrees.

In the contact for a vacuum interrupter according to the present invention, for each slot portion, it may be more effective that a distance to a second slot portion of the slot portion adjacent to a first end portion thereof has a predetermined second distance to induce a rotational movement of the arc.

In the contact for a vacuum interrupter according to the present invention, it may be more effective that the second distance is greater than or equal to 0.8 times the contact thickness and less than or equal to two times the contact thickness.

### BRIEF DESCRIPTION OF THE DRAWINGS

The accompanying drawings, which are comprised to provide a further understanding of the invention and are incorporated in and constitute a part of this specification, illustrate embodiments of the invention and together with the description serve to explain the principles of the invention.

In the drawings:

FIG. 1 is a cross-sectional view illustrating the configuration of a typical vacuum interrupter;

FIG. 2 is an explanatory view illustrating that an arc generated at the timing of opening and separating between contacts is pushed outward by a Lorentz force in the vacuum interrupter of FIG. 1;

FIG. 3 is an operational state diagram illustrating a current-flow pattern when contacts are being brought into contact with each other in the vacuum interrupter of FIG. 1;

FIG. 4 is a plan view of a contact illustrating the configuration of a contact of the vacuum interrupter according to an example of the related art;

FIG. 5 is a longitudinal cross-sectional view of FIG. 4;

FIG. 6 is a plan view of a contact illustrating the configuration of a contact of the vacuum interrupter according to another example of the related art;

FIG. 7 is a longitudinal cross-sectional view of FIG. 6;

FIG. 8 a plan view of a contact (movable contact or stationary contact) illustrating the configuration of a contact of the vacuum interrupter according to a preferred embodiment of the present invention;

FIG. 9 is a longitudinal cross-sectional view illustrating the shape of a contact of the vacuum interrupter according to a preferred embodiment of the present invention when the contact is longitudinally cut along the line A-A of FIG. 8;

FIG. 10 a perspective view of a contact (movable contact or stationary contact) illustrating the configuration of a contact of the vacuum interrupter according to a preferred embodiment of the present invention;

FIG. 11 is an operational state diagram illustrating the advancing movement state of an arc when contacts are being open and separated from each other in a contact of the vacuum interrupter according to a preferred embodiment of the present invention; and

FIG. 12 is a waveform diagram illustrating the voltage waveform of an arc when contacts are being open and separated from each other in a contact of the vacuum interrupter according to a preferred embodiment of the present invention.

### DETAILED DESCRIPTION OF THE INVENTION

The objective of the present invention, as well as the configuration and working effect thereof to accomplish the foregoing objective will be clearly understood by the following description for the preferred embodiments of present disclosure with reference to the accompanying drawings.

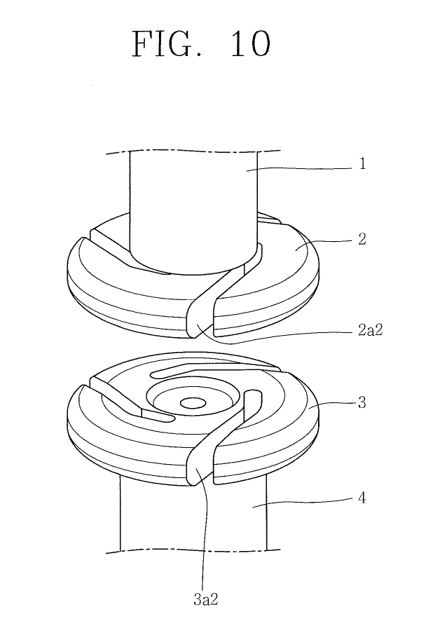

The contacts 2, 3 of a vacuum interrupter according to a preferred embodiment of the present invention may comprise a movable contact 2 and a stationary contact 3 as illustrated in FIG. 10. In FIG. 10, reference numerals 3a1, 2a1 designate slot portions, and reference numerals 1 and 4 designate a movable electrode and a stationary electrode, respectively. The overall configuration of a vacuum interrupter has been described above, and thus the description and illustration of portions thereof other than the configuration of a contact according to the present invention will be omitted to avoid duplication.

The contacts 2, 3 of a vacuum interrupter according to a preferred embodiment of the present invention has a horizontal magnetic field type contact, in which the current has a vertical direction and the magnetic field is formed perpendicular to the current, thus forming a horizontal magnetic field.

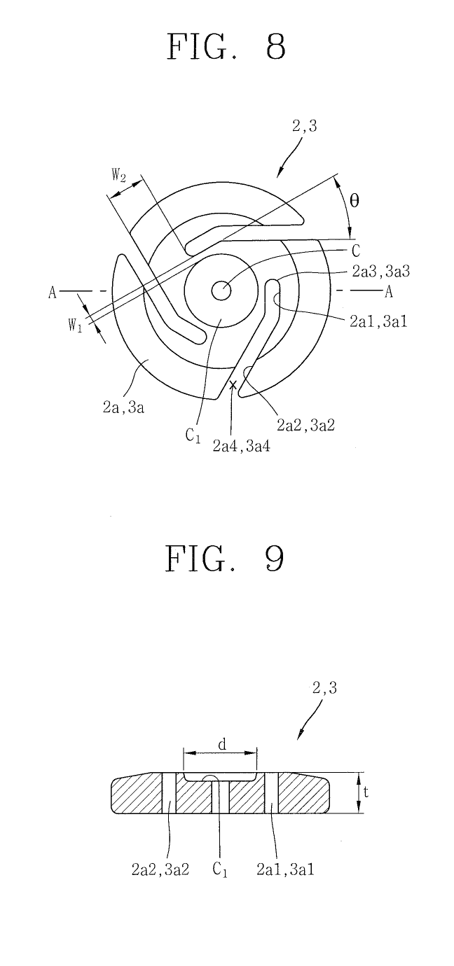

Referring to FIGS. 8 and 9, in a vacuum interrupter according to a preferred embodiment of the present invention, a movable contact 2 and a stationary contact 3, respectively, may comprise a plurality of slot portions, namely, slot portions 2a1, 2a2 of the movable contact 2 or slot portions 3a1, 3a2 of the stationary contact 3, and a petal portion, namely, a petal portion 2a of the movable contact 2 or a petal portion 3a of the stationary contact 3.

The plurality of slot portions 2a1, 2a2 or 3a1, 3a2 may be formed in an extended manner toward an outer circumferential surface from a plurality of (three in preferred embodiment) positions, respectively, spaced apart from the center (C) of a contact surface in the movable contact 2 and the stationary contact 3, respectively.

Three petal portions 2a, 3a may be provided respectively according to a preferred embodiment of the present invention with reference to FIGS. 8 and 10, and each petal portion 2a, 3a may be formed between a pair of the adjacent slot portions 2a1, 2a2 or 3a1, 3a2, and have a wing-like shape, and made of a material having conductivity.

In order to minimize a mechanical fragile part having a narrow width in the petal portion 2a, 3a while inducing the rotational movement of an arc, each of the slot portion 2a1, 2a2 or 3a1, 3a2 may comprise a first end portion 2a3, 3a3 that is closed and adjacent to the center (C), a second end portion 2a4, 3a4 that is open and adjacent to an outer circumferential surface of the movable contact 2 or stationary contact 3, a first slot portion 2a1, 3a1 linearly extended from the first end portion 2a3, 3a3, and a second slot portion 2a2, 3a2 linearly extended to the second end portion 2a4, 3a4 by bending from the first slot portion 2a1, 3a1 at a predetermined angle.

In other words, according to the feature of the present invention, the slot portion 2a1, 2a2 or 3a1, 3a2 may comprise a slot part linearly extended, and another slot part extended by bending from the slot part at a predetermined angle (θ), and thus a plurality of petal portions 2a, 3a formed by a pair of adjacent slot portions 2a1, 2a2 or 3a1, 3a2 may form a rotating wing shape to induce the rotation of an arc, and also a mechanical fragile part having a narrow width in the petal portion 2a, 3a can be minimized with a configuration in which slot portions are linearly extended and bended. Here, the predetermined angle (θ) may be preferably greater than or equal to 30 degrees and less than or equal to 60 degrees.

Referring to FIGS. 8 and 9, a vacuum interrupter according to a preferred embodiment of the present invention may comprise a central contact groove portion (C1) concavely formed with a predetermined diameter (d) from the center (C) of the contact.

In order to maintain a mechanical strength at the time of opening or closing the contact, a distance from an outer circumferential surface of the central contact groove portion (C1) to the first slot portion 2a1, 3a1 has a predetermined first distance (W1). Preferably, the predetermined first distance (W1) may be greater than zero and less than or equal to 5 mm.

The foregoing feature will be described in the following equation (1).

0<W1≦5 mm (1)

In order to maintain a mechanical strength at the time of opening or closing the contact, for each slot portion 2a1, 2a2 or 3a1, 3a2, a distance from the first end portion 2a3, 3a3 to a second slot portion 2a3, 3a2 of the slot portion adjacent to the first end portion 2a3, 3a3 thereof has a predetermined second distance (W2). Here, the second distance (W2) may be preferably greater than or equal to 0.8 times the contact thickness (refer to reference character “t” in FIG. 9) and less than or equal to two times the contact thickness (t).

The foregoing feature will be described in the following equation (2).

0.8t≦W2≦2t (2)

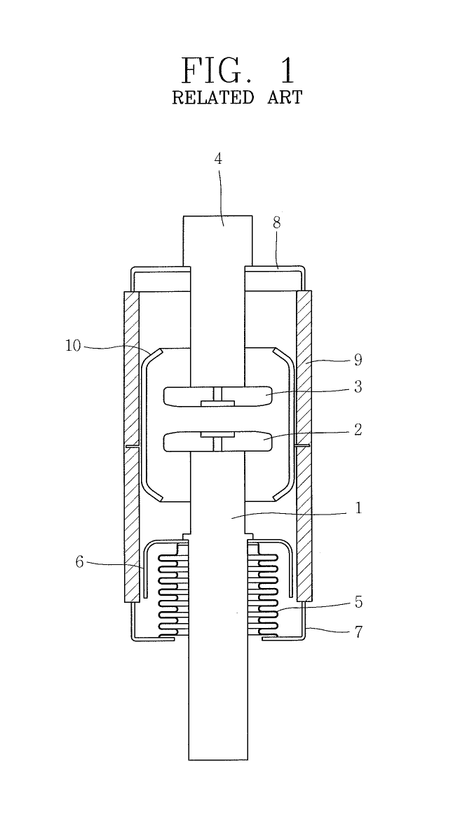

Referring to FIG. 10, in a vacuum interrupter according to a preferred embodiment of the present invention, the movable contact 2 and the stationary contact 3 may be connected to a movable electrode 1 and a stationary electrode 4 to be provided in the vacuum interrupter as illustrated in FIG. 1.

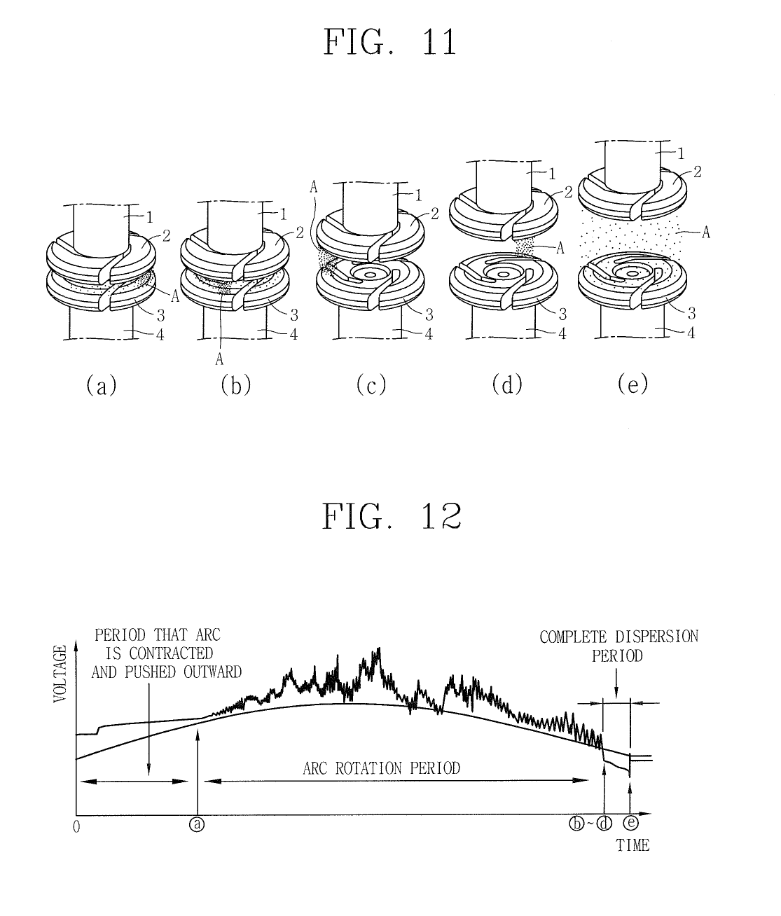

Meanwhile, the operation of a vacuum interrupter having the foregoing configuration according to the present invention will be described mainly with reference to FIGS. 11 and 12, and subsidiarily with reference to FIGS. 8 through 10.

First, the condition and effect in which contacts of the vacuum interrupter according to the present invention are being open and separated from each other to cut off the circuit based on the occurrence of a large current such as a short-circuit current on an electric power circuit connected to a vacuum circuit breaker including the vacuum interrupter will be described with reference to FIGS. 11 and 12.

The advancement from (a) to (e) in FIG. 11 illustrates the procedure of operation in which contacts are being open and separated from each other.

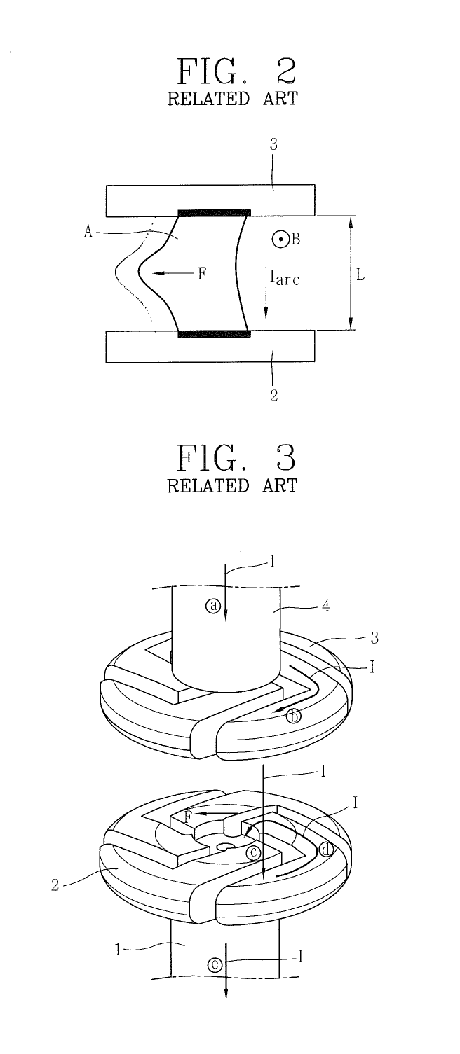

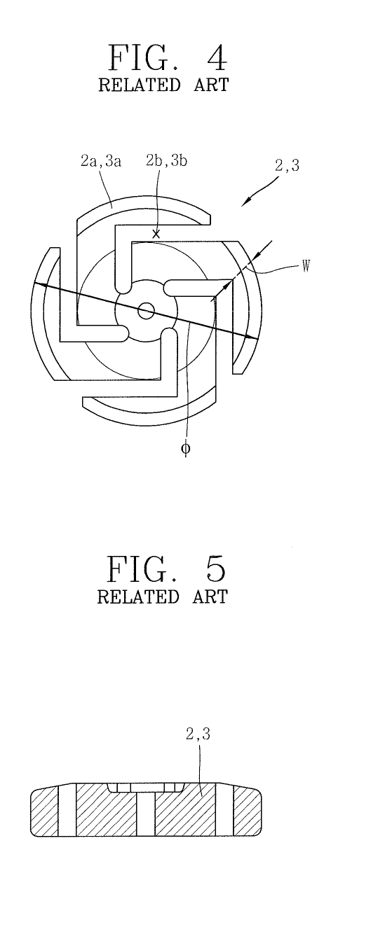

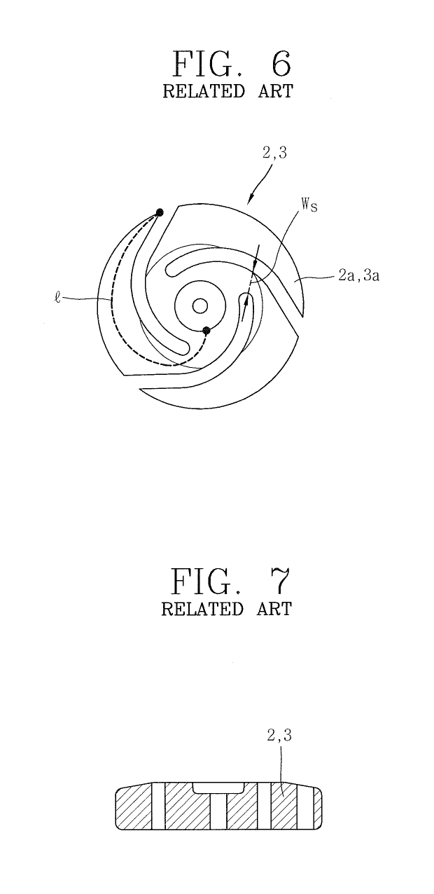

In (a) of FIG. 11, at the early stage when the movable contact 2 and the stationary contact 3 are being open and separated from each other, an arc (A) occurs in metal vapour while cutting off a large current, and the arc (A) is contracted in a column shape while being pushed outward by a Lorentz force between the movable contact 2 and the stationary contact 3 as described above with reference to FIG. 2, thereby having a generally constant voltage as illustrated in FIG. 12.

Subsequently, the arc (A) rotates along a contact surface while having a fluctuating voltage during the arc rotation period as illustrated in the drawings as increasing a distance between the movable contact 2 and the stationary contact 3 as illustrated in (b), (c) and (d) in FIG. 11.

Subsequently, the voltage of the arc (A) is abruptly reduced during the complete dispersion period as illustrated in FIG. 12, and completely dispersed to be disappeared as illustrated in (e) of FIG. 11.

In the movable contact 2 and the stationary contact 3 according to the present invention, the slot portion 2a1, 2a2 or 3a1, 3a2 may comprise a slot part linearly extended, and another slot part extended from the slot part by bending from the slot part at a predetermined angle (θ). Accordingly, a plurality of petal portions 2a, 3a formed by a pair of adjacent slot portions 2a1, 2a2 or 3a1, 3a2 may form a rotating wing shape to induce the rotation of an arc, thereby reducing a time of opening and separating and recovering insulation, namely, completely cutting off a fault current between the movable contact 2 and the stationary contact 3.

Furthermore, the condition and effect in which contacts of the vacuum interrupter according to the present invention are being closed to perform a circuit connection (closing) operation on the electric power circuit connected to a vacuum circuit breaker including the vacuum interrupter will be described with reference to FIG. 11.

The operation of moving contacts of the vacuum interrupter according to the present invention to a closed position enables the movable contact 2 and the stationary contact 3 to move to a position where they are brought into contact with each other, thus operating in the reverse order of the opening and separating operation as illustrated in FIGS. 11E to 11A. As a result, an arc (A) does not occur during the closed operation as illustrated in FIG. 11.

Though a large contact load is imposed on the movable contact 2 and the stationary contact 3 during the closed operation, the movable contact 2 and the stationary contact 3 according to the present invention have the shape of a slot portion 2a1, 2a2 or 3a1, 3a2 formed in a linearly bended manner and does not have a fragile part having a narrow width in the petal portion 2a, 3a on the contact surface, and thus the deformation or damage of the movable contact 2 and the stationary contact 3 may be prevented, thereby obtaining a effect of ensuring the switching performance and operation reliability and longer life of a vacuum interrupter.

Furthermore, the movable contact 2 and the stationary contact 3 of a vacuum interrupter according to a preferred embodiment of the present invention may further comprise a central contact groove portion (C1) concavely formed with a predetermined diameter (symbol “d” in FIG. 9) from the center (C) of the contact, and a distance from an outer circumferential surface of the central contact groove portion (C1) to the first slot portion 2a1, 3a1 may have a predetermined first distance (W1), thereby obtaining an effect of maintaining a mechanical strength of the relevant portion at the time of switching the contact.

In the contact for a vacuum interrupter according to the present invention, the predetermined first distance (W1) may be greater than zero and less than or equal to 5 mm, thereby obtaining an effect of maintaining a mechanical strength of the relevant portion at the time of switching the contact.

Furthermore, as illustrated in FIG. 8, in the contact for a vacuum interrupter according to the present invention, the predetermined angle (θ) may be greater than or equal to 30 degrees and less than or equal to 60 degrees to induce the rotational movement of an arc, thereby obtaining an effect of quickly extinguishing metal vapor in an arc as well as minimizing a mechanical fragile part having a narrow width in the petal portion.

In the contact for a vacuum interrupter according to the present invention, for each slot portion 2a1, 2a2 or 3a1, 3a2, a distance from the first end portion 2a3, 3a3 to a second slot portion 2a3, 3a2 of the slot portion adjacent to the first end portion 2a3, 3a3 thereof may have a predetermined second distance (W2), and thus a mechanical fragile part having a narrow width in the petal portion 2a, 3a may be minimized and deformation or damage due to a shock at the time of opening or closing the contact may be prevented, thereby obtaining an effect of maintaining a mechanical strength of the contact.

In the contact for a vacuum interrupter according to the present invention, the second distance (W2) may be preferably greater than or equal to 0.8 times the contact thickness (t) and less than or equal to two times the contact thickness (t), and thus a mechanical fragile part having a narrow width in the petal portion 2a, 3a may be minimized and deformation or damage due to a shock at the time of opening or closing the contact may be prevented, thereby obtaining an advantage of maintaining a mechanical strength of the contact.

What is claimed is:

1. A contact for a vacuum interrupter having a movable contact and a stationary contact,
each of the movable contact and stationary contact comprising:
a plurality of slot portions formed in an extended manner toward an outer circumferential surface from a plurality of positions, respectively, spaced apart from the center of a contact surface; and
a petal portion formed between a pair of the adjacent slot portions, and
wherein to minimize a mechanical fragile part having a narrow width in the petal portion while inducing the rotational movement of an arc,
each of the slot portion comprising:
a first end portion that is closed and adjacent to the center;
a second end portion that is open and adjacent to the outer circumferential surface;
a first slot portion linearly extended from the first end portion; and
a second slot portion linearly extended to the second end portion by bending from the first slot portion at a predetermined angle.

2. The contact for a vacuum interrupter of claim 1, further comprising:
a central contact groove portion concavely formed with a predetermined diameter from the center of the contact,
wherein a distance from an outer circumferential surface of the central contact groove portion to the first slot portion has a predetermined first distance to maintain a mechanical strength at the time of opening or closing the contact.

3. The contact for a vacuum interrupter of claim 2, wherein the predetermined first distance is greater than zero and less than or equal to 5 mm.

4. The contact for a vacuum interrupter of claim 1, wherein the predetermined angle is greater than or equal to 30 degrees and less than or equal to 60 degrees.

5. The contact for a vacuum interrupter of claim 1, wherein for each slot portion, a distance from the first end portion to a second slot portion of the slot portion adjacent to the first end portion has a predetermined second distance to maintain a mechanical strength at the time of opening or closing the contact.

6. The contact for a vacuum interrupter of claim 5, wherein the second distance is greater than or equal to 0.8 times the contact thickness and less than or equal to two times the contact thickness.
